(19) United States
(12) Patent Application Publication
(10) Pub. No.: US 2022/0296339 A1
(43) Pub. Date: Sep. 22, 2022

(54) HANDHELD INSTRUMENT FOR HOLDING A DENTAL BUR

(71) Applicant: Gerard Beauchemin, Lakehills, TX (US)

(72) Inventor: Gerard Beauchemin, Lakehills, TX (US)

(21) Appl. No.: 17/835,226

(22) Filed: Jun. 8, 2022

(51) Int. Cl. A61C 1/14

(52) U.S. Cl. CPC A61C 1/144; A61C 1/147; A61C 1/148

(57) ABSTRACT

Presented is a handheld dental bur that securely holds and offers secured tightening of a dental bur. The handheld dental bur includes a handle portion having a first end with a set of female threads and a second end to receive at least a tightening tool or a clamping tool. The handheld dental bur further includes a Micro-Chuck Assembly (MCA) that includes a collar with a hollow anterior, a collet with an elongated opening located in between multiple double-tapered prongs for receiving a shank portion of the dental bur, and a set of male threads. Further, the handheld dental bur includes a washer disposed of around an end of the collar separating the handle and the collar. The male threads of the collet engage with the female threads provided by the handle portion to detachably attach the MCA to the handle portion.

### FIELD OF INVENTION

The present disclosure relates to dental instruments in general. Particularly the present invention relates to a handheld instrument configured to secure a dental bur for performing safe dental procedures, particularly the removal of decayed tooth material (or cavity preparation) and enamel perforation without requiring oral or dental injections or powered rotary dental burs.

### BACKGROUND

Dental caries are small holes in teeth. It begins as a demineralization of the tooth surface and typically leads to the chronic, progressive destruction of the tooth. According to the Centers for Disease Control and Prevention (CDC), the percentage of children aged 5-19 years with untreated dental caries is 16.9% in the United States, whereas 31.6% of adults have untreated caries. CDC has also reported that the total prevalence of caries (both treated and untreated) is 45.8%. About 13% of those cases account for younger people, aged 2-19. If no proper dental treatment is taken on time, then expensive root canal treatment or extraction of the teeth, are the only treatment options left for a patient.

Traditionally in a caries treatment, the attacked tooth substance is removed by a dentist using a dental drill/bur or a spoon-shaped cutting excavator which is connected to a “handpiece” or other instrument handle. The handpiece is usually a slender, lightweight tube-shaped device connected to the dental drill/bur and has a driving motor or compressed air that aids in the rotary motion of the dental drill. Many forms of excavator drills/burs are available depending upon their applications. These powered handpieces with dental burs are expensive to purchase and repair. Furthermore, the uses of oral injections and powered dental drills are the most feared elements in dentistry.

These handpieces with powered rotary dental burs are not designed for just scraping away already softened dentine material and therefore could damage and frequently do damage healthy dentine that should never be removed.

During caries removal, the drilling and/or scraping motion should be carried out in different directions and repeated until all carious dentine gets removed, it might be hard work for the dentist to carry out the caries treatment without a proper dental instrument. The dentist has to position the instrument as well as control the instrument with his or her hand with respect to the scraping direction. At the same time, he or she has to ensure the scraping motion should not affect any of the healthy teeth. The dentist has to take care that not too much pressure gets applied from the instrument on the tooth. Also, the dentist has to remain cautious about the accidental dropping of the dental bur in the patient's mouth, or loosening of the dental bur (leading to movement of the dental bur) from the handpiece to which the dental burs are usually attached.

Loosening of the dental bur with respect to the handpiece or dropping out of the dental bur from the handpiece during the process can lead to a very painful and unpleasant experience for the patient and can even invite a medical emergency.

Recent research has involved the use of lasers to selectively burn out the caries prior to filling the tooth. Though the lasers are silent they nevertheless also inevitably remove a small portion of healthy dentin.

The prior art methods of caries removal based primarily on powered dental drills with the use of oral injections create at least some degree of fear in most patients, if not outright terror in some. Fear of the dentist prevents or at least hinders, innumerable patients from seeking or accepting the vitally needed dental treatment they need.

In order to address the issues discussed above, the inventor herein proposes a handheld mechanical tool that securely holds a dental bur for carrying out safer dental procedures, such as but not limited to the removal of decayed tooth material and some limited enamel in order to access underlying decay or infected dentin.

### SUMMARY

Before the present systems and methods, and embodiments are described, it is to be understood that this application is not limited to the particular systems, and methodologies described, as there can be multiple possible embodiments that are not expressly illustrated in the present disclosures. It is also to be understood that the terminology used in the description is for the purpose of describing the particular versions or embodiments only, and is not intended to limit the scope of the present application. Further, it is also to be understood that the terminology if not defined by the present disclosure should be construed as the general or known meaning/definition of the terminology, known to the person skilled in the art.

It is an objective of the present invention to provide a handheld dental instrument to securely and firmly hold a dental bur for carrying out a dental procedure such as caries excavation.

It is an object of this invention to provide a mechanical scraping or drilling instrument which facilitates a dentist to safely remove carious dentine holding the instrument in his or her hand. Specifically, it is an object of the invention to provide an improvised handheld instrument for securing a dental bur so that a dentist can concentrate on positioning the dental bur with full control. This means a more efficient treatment procedure.

It is another object of the present invention to provide a hand operable dental instrument that's easy to use, more economical caries excavation instrument using only gentle hand-power in place of costly and scary powered rotary instrumentation which also necessitates scary oral injections.

It is another objective of the present invention to provide a securely attached (though detachable) handheld instrument for anchoring a dental bur without any fear of the dental bur getting loose-or getting dropped within the mouth during a dental procedure.

According to one aspect of the present invention, the present invention provides a handheld dental bur. The handheld dental bur includes a handle portion having a first end and a second end, and the second end is configured to receive at least a tightening tool or a clamping tool, and the first end comprising a set of female threads provided at an interior surface of an opening.

According to the same aspect, the handheld dental bur includes a Micro-Chuck Assembly (MCA) that includes a collar having an exterior surface, and openings at two opposing ends forming a hollow anterior; a collet comprising an anterior end and a posterior end, wherein the anterior end of the collet comprises an elongated opening located in between at least three double-tapered prongs for receiving a shank portion of a dental bur, and the posterior end comprises a set of male threads, wherein each of the double-tapered prongs comprises an anterior tapered end and a posterior tapered end; and a washer disposed of around an end of the collar separating the first end of the handle portion and the collar.

According to the same aspect, the set of male threads provided at the posterior end of the collet engages with the set of female threads provided at the interior surface of the opening of the handle portion to detachably attach the MCA to the handle portion.

According to another aspect of the present invention, there is provided a handheld dental bur. The handheld dental bur includes a handle portion having a first end and a second end, the second end comprising a perforation hole configured for receiving a lock pin, and the first end comprising a set of female threads provided at an interior surface of an opening.

According to the same aspect, the handheld dental bur includes a Micro-Chuck Assembly (MCA). The MCA includes a 2 mm thick heavy-duty collar having an exterior surface, openings at two opposing ends forming a hollow anterior, and a pair of slots opposingly disposed on the outer surface of the collar; a collet comprising an anterior end and a posterior end, wherein the anterior end of the collet comprises an elongated opening located in between at least three double-tapered prongs for receiving a shank portion of a dental bur, and the posterior end comprises a set of male threads, wherein each of the double-tapered prongs comprises an anterior tapered end and a posterior tapered end; and a washer disposed of around an end of the collar separating the first end of the handle portion and the collar.

According to yet another aspect of the present invention, a handheld dental bur includes a handle portion having a first end and a second end, the second end comprising a perforation hole configured for receiving a lock pin locking, and the first end comprising a set of female threads provided at an interior surface of an opening.

According to the same aspect, the handheld dental bur further includes a Micro-Chuck Assembly (MCA) including a 1 mm thick light-duty collar having an exterior surface, openings at two opposing ends forming a hollow anterior, and knurling provided on the exterior surface; a collet comprising an anterior end and a posterior end, wherein the anterior end of the collet comprises an elongated opening located in between at least three double-tapered prongs for receiving a shank portion of a dental bur, and the posterior end comprises a set of male threads, wherein each of the double-tapered prongs comprises an anterior tapered end and a posterior tapered end, and a washer disposed of around an end of the collar separating the first end of the handle portion and the collar.

According to the same aspect, the set of male threads provided at the posterior end of the collet engages with the set of female threads provided at the interior surface of the opening of the handle portion to detachably attach the MCA to the handle portion.

According to the same aspect, the handheld dental bur includes, the knurling provided on the exterior surface of the 1 mm thick light-duty collar helps in gripping the collar using a clamping tool; and the gripping of the collar and reception of the lock pin within the perforation hole helps in applying required torque for tightening of the MCA with respect to the handle portion.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

So that the manner in which the above-recited features of the present invention can be understood in detail, a more particular description of the invention, briefly summarized above, may have been referred to by embodiments, some of which are illustrated in the appended drawings. It is to be noted, however, that the appended drawings illustrate only typical embodiments of this invention and are therefore not to be considered limiting of its scope, for the invention may admit to other equally effective embodiments. These and other features, benefits, and advantages of the present invention will become apparent by reference to the following text figure, with like reference numbers referring to like structures across the views, wherein:

FIG. 1 shows an assembled view of a handheld instrument securely holding a dentist's dental bur, according to an exemplary embodiment.

FIG. 2 shows an exploded view of the handheld instrument of FIG. 1.

FIG. 3 shows another exploded view of the handheld instrument of FIG. 1.

FIG. 4 shows the application of torque for tightening a Micro-Chuck Assembly (MCA) of the handheld instrument of FIG. 1 using a wrench and a lock pin, according to one exemplary embodiment.

FIG. 5 shows a front perspective view of a collet of the Micro-Chuck Assembly (MCA).

FIG. 6 shows an assembled view of a handheld instrument securely holding a dentist's dental bur, according to another exemplary embodiment of the present invention.

FIG. 7 shows an exploded view of the handheld instrument of FIG. 6.

FIG. 8 shows an assembled view of a handheld instrument securely holding a dentist's dental bur, according to yet another exemplary embodiment of the present invention.

FIG. 9 shows an exploded view of the handheld instrument of FIG. 8.

FIG. 10 shows the application of torque for tightening a Micro-Chuck Assembly (MCA) of the handheld instrument of FIG. 8.

FIG. 11 shows an exemplary clamping tool other than the clamping tools shown in FIG. 10.

### DETAILED DESCRIPTION

Before describing the present invention in detail, it should be observed that the present invention utilizes a combination of components or processes, which constitutes a handheld dental bur that securely grips or holds in place a dental bur. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Some embodiments, illustrating its features, will now be discussed in detail. The words “comprising,” “having,” “containing,” and “including,” and other forms thereof, are intended to be equivalent in meaning and open-ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

References to “one embodiment”, “an embodiment”, “another embodiment”, “one example”, “an example”, “another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The present subject matter discloses a handheld instrument for securing a dental bur used for carrying out dental procedures such as caries removal from a decayed tooth. The handheld instrument (hereinafter also referred to as “handheld dental bur” is designed to securely grip or hold in place a dental bur via a friction-grip attachment mechanism. Further, an array of handheld gripping tools such as a wrench, and one or more types of clamping tools are usable with the proposed handheld dental bur to apply needed torque to tighten the Micro-Chuck Assembly (MCA) gripping the dental bur being used for carrying our dental procedure such as for example caries excavation (decay removal), enamel perforation and so on. The proposed handheld dental bur centers on the secure tightening of the dental bur.

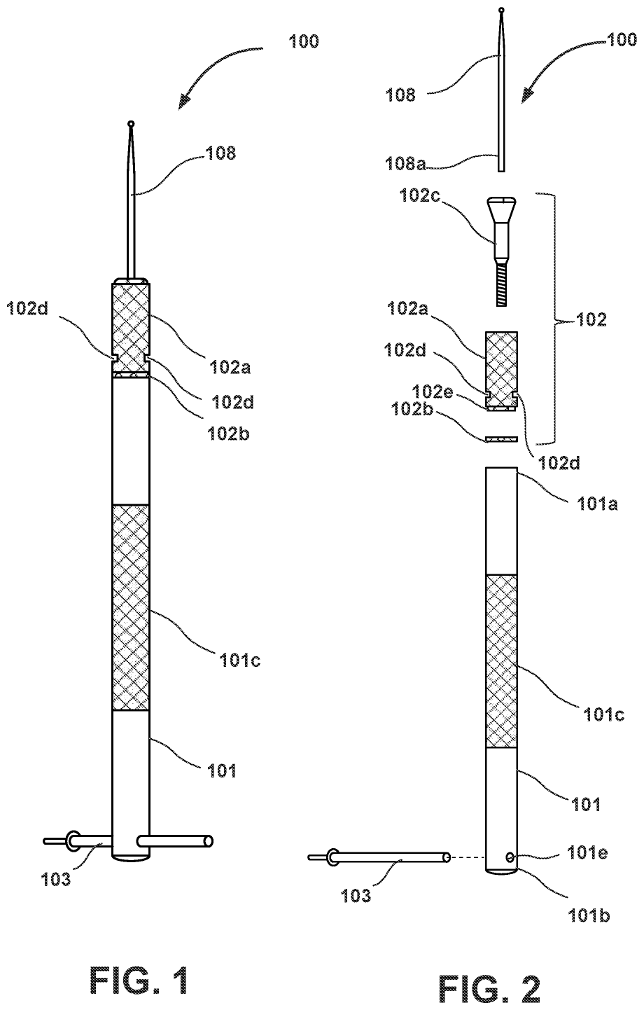

The handheld dental bur or handheld instrument for securely gripping or holding the dental bur will now be described with reference to the accompanying drawings, particularly FIGS. 1-11.

Referring to FIGS. 1-3, a handheld instrument or handheld dental bur for securely holding a dentist's dental bur according to an exemplary embodiment is shown. As seen, the handheld dental bur 100 includes an elongated handle portion 101 and a Micro-Chuck Assembly (MCA) 102. The handheld dental bur 100 is ergonomic, round, comfortable to hold, and lightweight. In an example embodiment, the weight of the handheld dental bur 100 may be about 11.1 grams. In an exemplary embodiment, the handheld dental bur (with the dental bur 108 fitted) has a length of 117 mm which keeps the user's hand away from obstructing his/her view into the oral cavity and it permits ample light to enter the mouth. The length of the handle 101 is chosen suitably for carrying out dental procedures and not very long that can become cumbersome to manipulate the instrument during dental procedures.

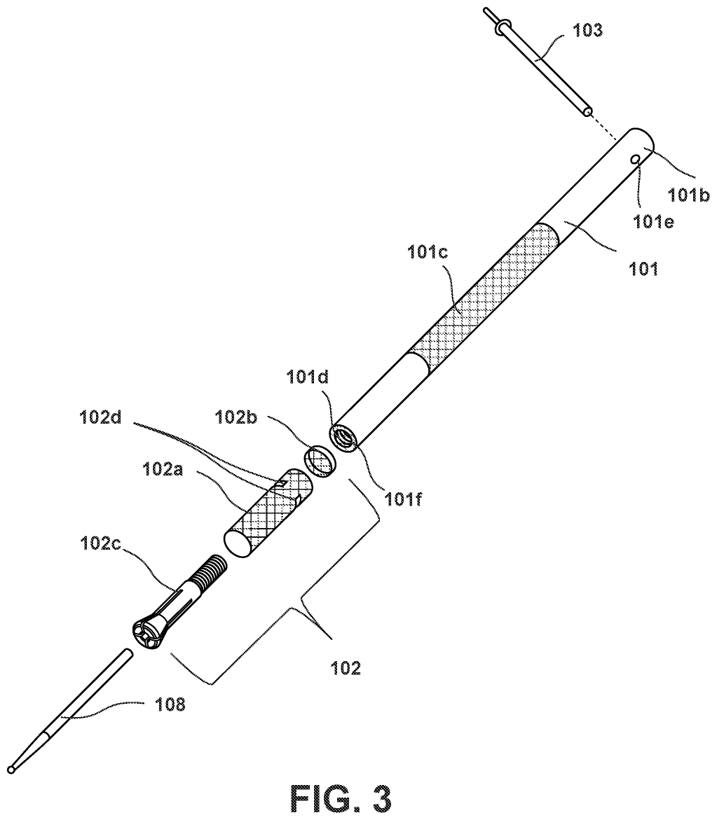

The handle portion 101 is tubular or cylindrical in shape. However, it should be understood that the handle portion 101 may be configured in different other shapes as well. The handle portion 101 is dimensioned such that it offers an ergonomic grip and sleek design. The handle portion 101 is made using a metallic material such as but not limited to aluminum. The handle portion 101 comprises a first end 101a and a second end 101b. The first end 101a includes an opening 101f having a set of female threads 101d at an interior surface as seen in FIG. 3. The second end 101b includes a perforation hole 101e (of a predetermined diameter) preferably configured for receiving a tightening tool according to one embodiment. The diameter of the hole 101e is kept such that the tightening tool 103 can pass therethrough. The perforation hole 101e at the second end 101b of the handle 101 is easily accessible and offers optimum water drainage after sterilization of the instrument 100. This minimizes the risk of occurrence of corrosion. In an embodiment, the tightening tool is a lock pin 103. The handle portion 101 may also include knurling (small ridges) 101c formed on its exterior surface for offering a better gripping experience to a user of the instrument 100.

The MCA 102 includes a collar or sleeve 102a, a washer 102b, and a collet 102c as seen in FIG. 2. The MCA 102 is configured to removably connect to the handle portion 101.

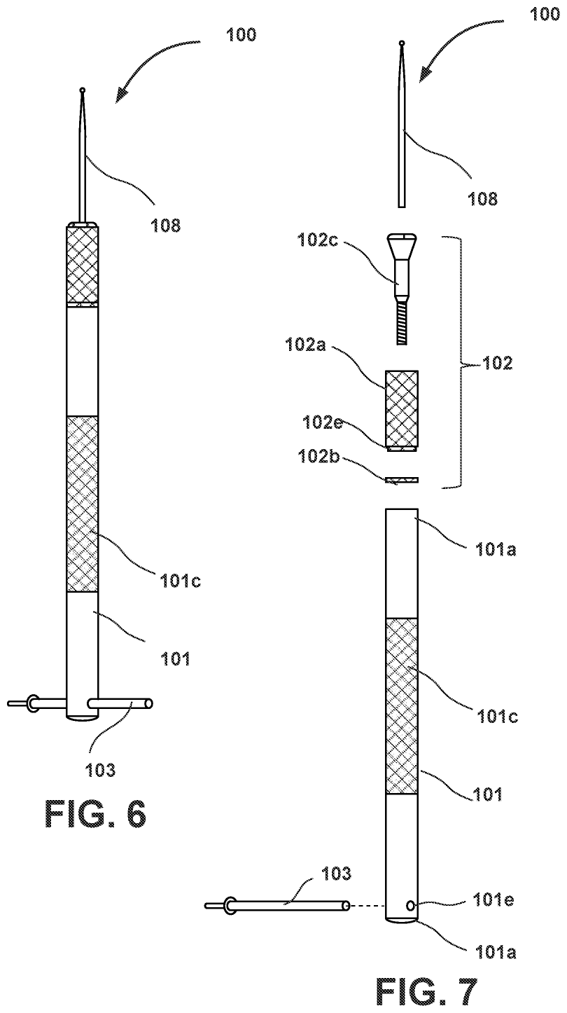

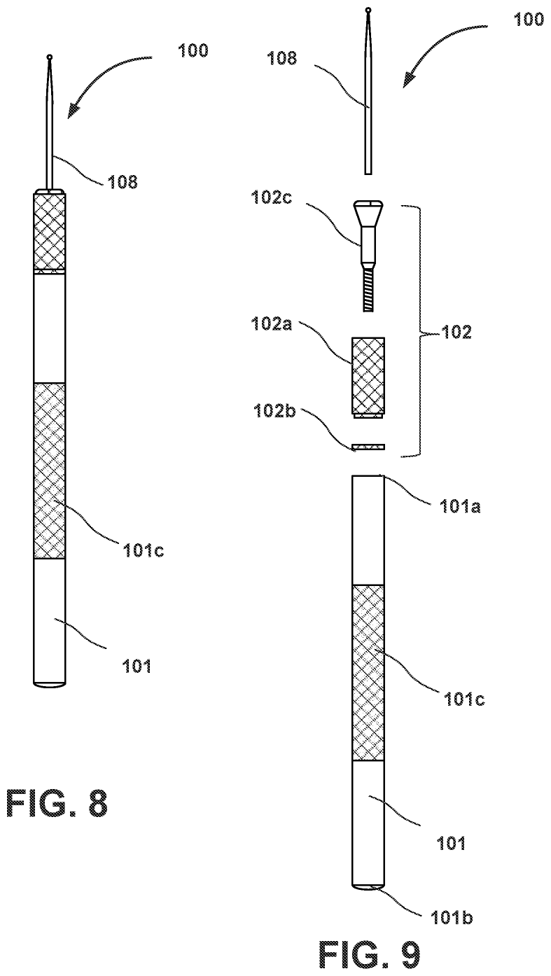

The collar 102a of the MCA 102 includes a pair of slots 102d opposingly disposed on the collar's 102a exterior surface according to an embodiment. In another embodiment, the collar 102a may not include the slots 102d as seen in FIGS. 6 and 8. The collar 102a, in some embodiments, has a rounded superior end for a comfortable grip. The collar 102a is hollow with openings at two ends. The collar or sleeve 102a is made of medical-grade 6061-T6 aluminium or any other suitable material known in the art. The collar 102a is made robust and is designed to withstand excessive hand-powered forces with extensive and repeated use without becoming deformed and ineffective.

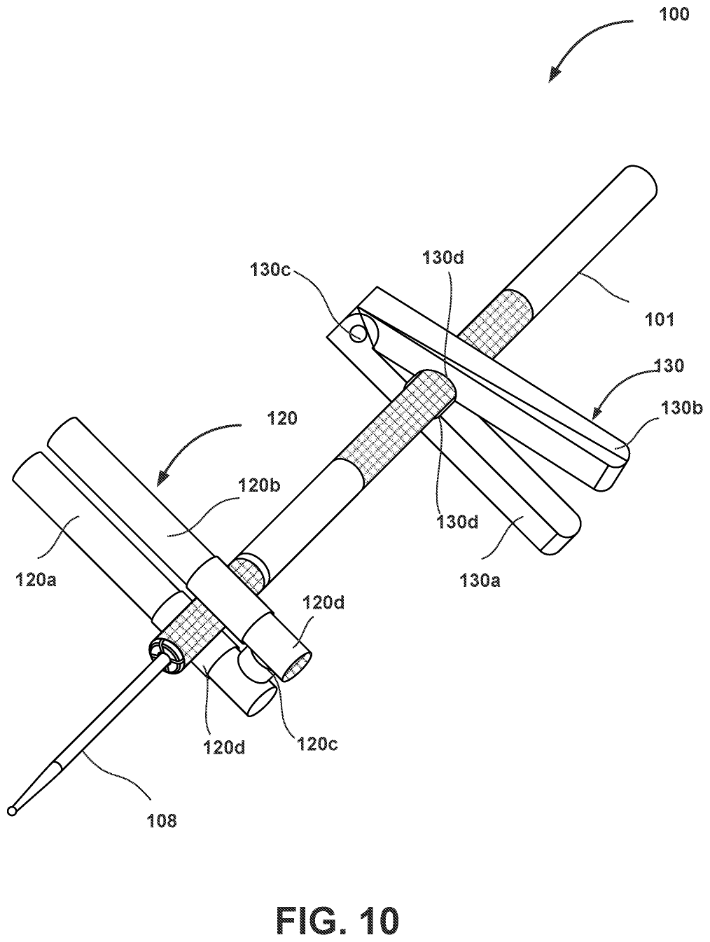

According to the embodiment, the collar 102a may be a 1 mm thick light-duty collar, or a 2 mm thick heavy-duty collar. In an embodiment, the collar 102a may be provided with small ridges (knurling) on the outer surface for better gripping. In another embodiment, the collar 102a may not be provided with knurling on the outer surface. In one preferred embodiment, the 2 mm thick heavy-duty collar 102a may include a pair of grooves 102d without knurling because the gripping tool (Eg. wrench) would grip the collar 102a instead. In another preferred embodiment, the 1 mm thick light-duty collar 102a may be provided with knurling but with no grooves on the outer surface for better gripping using some type of clamping tool as shown in FIG. 10.

Referring to FIG. 5, the collet 102c comprises an anterior end 104a and a posterior end 104b. The anterior end 104a includes at least three tapered prongs 105 with each prong 105 having an anterior tapered end and a posterior tapered end. In an example shown, four tapered prongs 105 are shown, however, it is possible to have three or, five or six prongs. The posterior end 104b of the collet 102c includes a set of male threads 106 that helps in the engagement of the collet 102c with the handle portion 101 (via female threads 101d provided on the handle 101). In between the four prongs 105, there is present an elongated opening 107 for receiving a shank portion 108a of a dental bur 108. The shank portion of the dental bur 108 may be partially or fully received within the opening 107 and gripped by at least three prongs or four prongs 105. The opening 107 is suitable enough in dimension to anchor any standard-sized 2.35 mm dental bur.

As seen in FIGS. 1 and 2, a washer 102b interconnects the handle portion 101 with the collar 102a. The washer 102b is a ring-like structure and sits around an end 102e of the collar 102a. The washer 102b protects the handle 101 and the collar 102a from grating and friction. The handle portion 101 and the collar 102a are usually made of aluminum or similar material and are prone to grating and friction due to aluminum-to-aluminum contact in the due course. The flat and thin washer 102b disposed between the collar 102a and the handle 101 is strong. In an exemplary embodiment, the washer 102b is made of anti-friction stainless steel. The washer 102b for example has an inner diameter of 0.2510 inches, an outer diameter of 0.3290 inches, and a thickness of 0.010 inches. The use of washer 102b as a separating element between the collar 102a and the first end 101a of the handle portion 101 prolongs the handheld dental bur's 100 service life.

During assembly, firstly the posterior end 104b of the collet 102c is made to slide through the hollow interior of the collar 102a and then through the thin washer 102b which separates the first end 101a of the handle portion 101 and the collar 102a. This now permits the collet's male threads 106 to rotatably engage with the female threads 101d provided at the interior surface at the first end 101a of the handle portion 101. But before rotably engaging the female threads 101d for actual tightening, the shank portion 108a of the dental bur 108 is inserted within the opening 107 surrounded by the four prongs 105 of the collet 102c. Lastly, when handle rotation or actual tightening against the collet 102c begins, it forces the collar 102a to move upward from the posterior tapered ends toward the anterior tapered ends of the four prongs 105 which then squeezes the prongs 105 together against the dental-bur 108 held between the four prongs 105. Thus, the dental-bur (shank 108a of the dental bur 108) is securely gripped by the four prongs 105 of the collet 102c. An upward force is developed as the female threads 101d in the handle portion 101 screw over the male threads 106 of the collet 102c and travels a predetermined insertion depth. In an exemplary embodiment, the insertion depth is a minimum of 5 mm for secure operation.

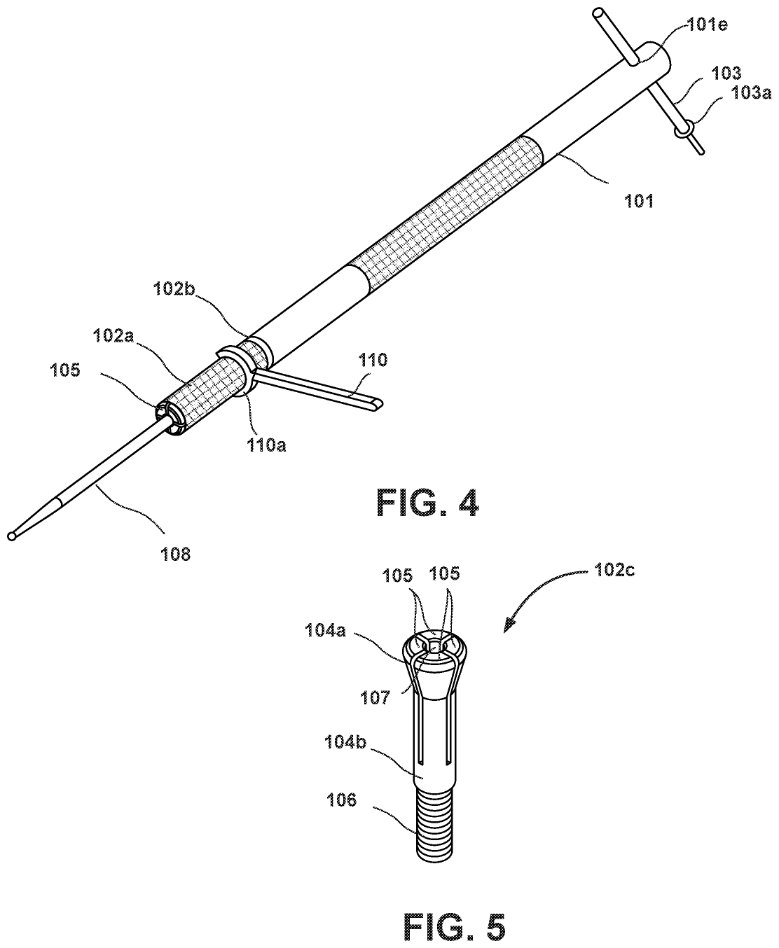

Once the MCA 102 (with the dental bur 108) is connected or engaged to the handle portion 101, and in order to ensure the dental bur 108 is properly or tightly held in between prongs 105, one or more gripping tools 110 or clamping tools 120,130,140 can be further used to apply torque and tighten the MCA 102 with respect to the handle portion 101 as shown in FIGS. 4 and 10.

FIG. 4 shows the application of torque for tightening a Micro-Chuck Assembly (MCA) of the handheld instrument 100 using a wrench 110 and a lock pin 103. In operation, the user places the mouth or jaws 110a of the wrench 110 over the slots 102d for gripping the MCA 102, and simultaneously the user inserts the lock pin 103 into the perforation hole 101e provided on the handle 101 and then applies the required torque (using the wrench 110 and the pin 103) to achieve controlled rotation for the MCA 102 to make sure the MCA 102 is sufficiently tightened with respect to the handle portion 101. The torque is applied in the opposing directions in order to either tighten or loosen the MCA 102 from the handle portion 101. Or the wrench 110 may just function to grip the MCA 102 and the rotational torque may just be applied using the pin 103 for more precise tightening of the instrument. Although the pin 103 shown has a specific design with a stopper 103a at one end. It should be understood that any other tightening tools or lock pins may be used with a suitable diameter to allow it to pass through the hole 101e. The tightening tool may be any type of small steel pin such as and not limited to a long-stem dental bur or stainless-steel rivet, that can fit perforation hole 101e and used to tighten/loosen the MCA 102 using mild finger pressure. Light finger pressure prevents over-tightening of the collets' friction grip prongs 105 thereby extending the MCA's service life.

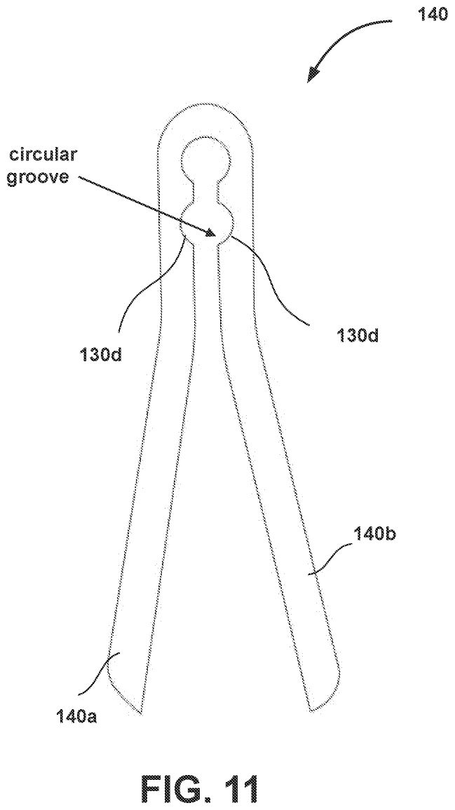

On the other hand, FIG. 10 shows the application of torque for tightening the MCA 102 of the handheld instrument 100 that does not have slots on the collar 102a and also does not have the perforation hole for using the lock pin on the handle 101 as shown in FIGS. 8 and 9. As seen, the collar 102a used herein may be a 1 mm thick light-duty collar 102a provided with knurling but with no grooves on the outer surface for better gripping. One can engage a variety of gripping tools or other types of clamping tools over the collar's exterior surface and the handle portion 101. Particularly, FIG. 10 shows the use of two different clamping tools 120, and 130. A user can hold the instrument 100 over the collar 102a and the handle 101 respectively, and apply the required torque to tighten the MCA 102 with respect to the handle 101. However, although not shown, it is equally possible to use similar clamping tools 120, 130,140 to clamp the collar 102a and the handle 101. The clamp 120 for example, as seen, includes two arms 120a, and 120b. Each arm 120a, and 120b includes a smooth surface. The two arms 120a and 120b have a hinged connection at a point 120c to allow manipulation of the clamp 120 so as to hold or release the collar 102a of the MCA 102. The clamp 120 would help in gripping and/or twisting the MCA 102 with limited torque. This minimum clamp torque also prevents excessive collet gripping force which extends the MCA's service life. In addition, the clamp's smooth gripping surface prevents handle marring. Although the clamp 120 is shown gripping the collar 102a, it should be understood that the clamp 120 may be used to grip the handle 101. Another clamping tool example 130 is adapted for holding and applying torque on the handle portion 101. Although FIG. 10 shows the clamp 130 gripping the handle 101, it should be understood that the clamp 130 can also be used for holding/gripping the collar 102a. As seen, the clamp 130 includes a lower jaw 130a and an upper jaw 130b. The lower and upper jaws 130a and 130b are connected at a hinged point 130c to allow manipulation of the clamp 130. Each of the lower and upper jaws 130a,130b includes a half-cylindrical grooves 130d. The lower jaw and the upper jaws 130a, and 130b meet to form a circular gripping area. In operation, while holding/gripping the handle 101 or the collar 102a the two jaws 130a, 130b hold or retain the handle portion 101 or collar 102a within these grooves 130d forming a circular groove. Another clamping tool example, as shown in FIG. 11 can also be used instead. The clamping tool 140 is similar to clamp 130 but with no hinged pin used. The clamping tool 140 embodies a 180° flexible bend in thin 2 mm aluminum. Only the smaller, posterior circle is for clamping, the larger superior circle is merely part of this clamp's design for flexibility. One skilled in the art can understand that instead of using clamps 120 and/or 130, one can use clamp 140 alone or in combination with other clamps 120,130. The clamps 120, 130, and 140 are preferably made of aluminium and designed to provide moderate gripping force. The smooth circular grooves (in clamps 130,140) or soft vinyl 120d (in clamp 120) that grip the instrument 100 over the handle portion 101 or the collar 102a offer resistance against over-tightening. They will slip if too much torque is applied. Controlled torque tightening maximizes the handheld bur's service life. FIG. 10 shows the use of two different clamping tools 120, and 130. However, it should be clearly understood that clamp 140 can also be used as a substitute for clamps 120, 130. It is equally possible to use any other clamping tools similar to the clamping tools 120, 130, or 140 to clamp the collar 102a and/or handle portion 101, and thus using specific clamping tools 120,130,140 described here should not be construed as a limitation.

The disclosed handheld dental bur has many advantages. The handheld dental bur facilitates the medical management of caries and will enable dental practitioners across the globe to treat dental decay without dental injections or powered rotary dental drills. The handheld dental bur is light, which makes it ideal for patients with acute dental pain. Also, the handheld dental bur's ergonomic grip and sleek design make it even aesthetically acceptable among dentists. Furthermore, the handheld dental bur is usable with the other tightening tools, and clamping tools discussed above to prevent over-torquing of the handle, thus providing better service life when compared to the existing devices in use. In addition, the gentle use of hand-burs treats teeth without any additional trauma, increasing the rate of pulpal healing, and reducing pain and tooth loss.

It should be understood that the various components and assemblies of the various embodiments of a handheld dental bur 100 of the present invention are similar and interchangeable. It is obvious to the one skilled in the art that the various components and assemblies of the handheld dental bur 100 of one embodiment of the present invention could be considered for other embodiments with little or no variation.

It should be understood according to the preceding description of the present invention that the same is susceptible to changes, modifications and adaptations, and that the said changes, modifications and adaptations fall within scope of the appended claims.

What is claimed is:

1. A handheld dental bur (100), comprising:
a handle portion (101) having a first end (101a) and a second end (101b), the second end (101b) is configured to receive at least a tightening tool (103) or a clamping tool (120,130,140), and the first end comprising a set of female threads (101d) provided at an interior surface of an opening (101f);
a Micro-Chuck Assembly (MCA) (102) comprising:
a collar (102a) having an exterior surface, and openings at two opposing ends forming a hollow anterior;
a collet (102c) comprising an anterior end (104a) and a posterior end (104b), wherein the anterior end (104a) of the collet (102c) comprises an elongated opening (107) located in between at least three double-tapered prongs (105) for receiving a shank portion (108a) of a dental bur (108), and the posterior end (104b) comprises a set of male threads (106), wherein each of the double-tapered prongs (105) comprises an anterior tapered end and a posterior tapered end;
a washer (102b) disposed of around an end (102e) of the collar (102a) separating the first end (101a) of the handle portion (101) and the collar (102a); and
wherein the set of male threads (106) provided at the posterior end (104b) of the collet (102c) engages with the set of female threads (101d) provided at the interior surface of the opening (101f) of the handle portion (101) to detachably attach the MCA (102) to the handle portion (101).

2. The handheld dental bur (100) as claimed in claim 1, wherein the posterior end (104b) of the collet (102c) is configured to slide through the hollow interior of the collar (102a), thereby forcing the collar (102a) up the posterior tapered ends of at least three double-tapered prongs (105) in order to squeeze at least three double-tapered prongs (105) together against the shank portion (108a) of the dental bur (108).

3. The handheld dental bur (100) as claimed in claim 1, wherein the collar (102a) comprises a pair of slots (102d) with each of the slots (102d) being opposingly disposed on the outer surface of the collar (102a).

4. The handheld dental bur (100) as claimed in claim 1, wherein, the external surface of the collar 102a comprises knurling for better gripping.

5. The handheld dental bur (100) as claimed in claim 1, wherein the handle portion (101) comprises knurling (101c) formed on an exterior surface for providing a better gripping experience to a user of the handheld dental bur (100).

6. The handheld dental bur (100) as claimed in claim 1, wherein the second end (101b) of the handle portion (101) comprises a perforation hole (101e) of a predetermined diameter.

7. The handheld dental bur (100) as claimed in claim 6, wherein the perforation hole (101e) receives the tightening tool for tightening the MCA (102).

8. The handheld dental bur (100) as claimed in claim 1, wherein the tightening tool is at least a lock pin (103), a long-stem dental bur, or a stainless-steel rivet that can fit into the perforation hole (101e).

9. The handheld dental bur (100) as claimed in claim 8, wherein the tightening tool is configured to apply controlled torque on the handle portion (101).

10. The handheld dental bur (100) as claimed in claim 1, wherein the clamping tool (120,130,140) is adapted to hold the handheld dental bur (100) over the collar (102a) and the handle portion (101) for applying the required torque to twist and tighten the MCA (102) with respect to the handle portion (101).

11. The handheld dental bur (100) as claimed in claim 10, wherein the clamping tool (120) comprises a first arm (120a) with a smooth surface, and a second arm (120b) with a smooth surface and being hingedly connected at a point (120c) to allow manipulation of the clamp (120) so as to hold or release the collar (102a) of the MCA (102) or the handle portion (101).

12. The handheld dental bur (100) as claimed in claim 10, wherein the clamping tool (130) includes a lower jaw (130a) and an upper jaw (130b) connected at a hinged point (130c) using a hinged pin to allow manipulation of the clamping tool (130) and wherein each of the lower and upper jaws (130a,130b) include an identical half-cylindrical groove (130d).

13. The handheld dental bur (100) as claimed in claim 10, wherein the clamping tool (140), similar to (130) with a lower and upper jaw with identical half-cylindrical grooves (130d), and comprises no hinged point (130c).

14. The handheld dental bur (100) as claimed in claim 3, wherein the pair of slots (102d) opposingly disposed on the outer surface of the collar (102a) are configured to receive a gripping tool (110).

15. The handheld dental bur (100) as claimed in claim 14, wherein the gripping tool (110) is a wrench (110).

16. The handheld dental bur (100) as claimed in claim 1, wherein the collar (102a) is a 1 mm thick light-duty collar, or a 2 mm thick heavy-duty collar.

17. The handheld dental bur (100) as claimed in claim 1, wherein the washer (102b) is made of anti-friction stainless steel and adapted to protect the handle portion (101) and the collar (102a) from grating and friction.

18. A handheld dental bur (100), comprising:
a handle portion (101) having a first end (101a) and a second end (101b), the second end (101b) comprising a perforation hole (101e) configured for receiving a lock pin (103), and the first end comprising a set of female threads (101d) provided at an interior surface of an opening (1011);
a Micro-Chuck Assembly (MCA) (102) comprising:
a 2 mm thick heavy-duty collar (102a) having an exterior surface, openings at two opposing ends forming a hollow anterior, and a pair of slots (102d) opposingly disposed on the outer surface of the collar (102a);
a collet (102c) comprising an anterior end (104a) and a posterior end (104b), wherein the anterior end (104a) of the collet (102c) comprises an elongated opening (107) located in between at least three double-tapered prongs (105) for receiving a shank portion (108a) of a dental bur (108), and the posterior end (104b) comprises a set of male threads (106), wherein each of the double-tapered prongs (105) comprises an anterior tapered end and a posterior tapered end;
a washer (102b) disposed of around an end (102e) of the collar (102a) separating the first end (101a) of the handle portion (101) and the collar (102a);
wherein the set of male threads (106) provided at the posterior end (104b) of the collet (102c) engages with the set of female threads (101d) provided at the interior surface of the opening (101f) of the handle portion (101) to detachably attach the MCA (102) to the handle portion (101); and
wherein the pair of slots (102d) on the outer surface of the collar (102a) are configured to receive a gripping tool (110).

19. The handheld dental bur (100) as claimed in claim 18, wherein the gripping tool (110) is a wrench (110).

20. A handheld dental bur (100), comprising:
a handle portion (101) having a first end (101a) and a second end (101b), the second end (101b) comprising a perforation hole (101e) configured for receiving a lock pin (103), and the first end comprising a set of female threads (101d) provided at an interior surface of an opening (1010;
a Micro-Chuck Assembly (MCA) (102) comprising:
a 1 mm thick light-duty collar (102a) having an exterior surface, openings at two opposing ends forming a hollow anterior, and knurling provided on the exterior surface;
a collet (102c) comprising an anterior end (104a) and a posterior end (104b), wherein the anterior end (104a) of the collet (102c) comprises an elongated opening (107) located in between at least three double-tapered prongs (105) for receiving a shank portion (108a) of a dental bur (108), and the posterior end (104b) comprises a set of male threads (106), wherein each of the double-tapered prongs (105) comprises an anterior tapered end and a posterior tapered end;
a washer (102b) disposed of around an end (102e) of the collar (102a) separating the first end (101a) of the handle portion (101) and the collar (102a);
wherein the set of male threads (106) provided at the posterior end (104b) of the collet (102c) engages with the set of female threads (101d) provided at the interior surface of the opening (101f) of the handle portion (101) to detachably attach the MCA (102) to the handle portion (101);
wherein, the knurling provided on the exterior surface of the 1 mm thick light-duty collar (102a) helps in gripping the collar (102a) using a clamping tool (120,130,140); and
wherein the gripping of the collar (102a) and reception of the lock pin (103) within the perforation hole (101e) helps in applying required torque for tightening of the MCA (102) with respect to the handle portion (101).
